(19) United States
(12) Patent Application Publication
(10) Pub. No.: US 2014/0342582 A1
(43) Pub. Date: Nov. 20, 2014

(54) ATTACHMENT MECHANISM FOR FASTENING EXPANSION CARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: SONG MA, Shenzhen (CN); LI-REN FU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/056,970

(22) Filed: Oct. 18, 2013

(30) Foreign Application Priority Data
May 17, 2013 (CN) 2013101825632

(51) Int. Cl. H01R 13/629

(52) U.S. Cl. CPC H01R 13/629
USPC 439/64

(57) ABSTRACT

An attachment mechanism for fastening an expansion card includes a circuit board, a positioning member, and a receiving member. The circuit board includes a first connector electrically connected to a second connector of the expansion card. The positioning member is fastened to the circuit board. The receiving member receives the expansion card. The receiving member engages with the positioning member.

### BACKGROUND

1. Technical Field

The present disclosure relates to an attachment mechanism for fastening an expansion card to a circuit board.

2. Description of Related Art

In servers, expansion cards are electrically connected to a circuit board through connectors of the circuit board. However, the connectors may not be securely fastened to the circuit board and the expansion cards may disengage from the connectors, both of which adversely influence data transmission of the server. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an attachment mechanism together with an expansion card.

FIG. 2 is similar to FIG. 1, but viewed from another perspective.

FIG. 3 is an assembled, isometric view of FIG. 1.

FIG. 4 is an assembled, isometric view of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

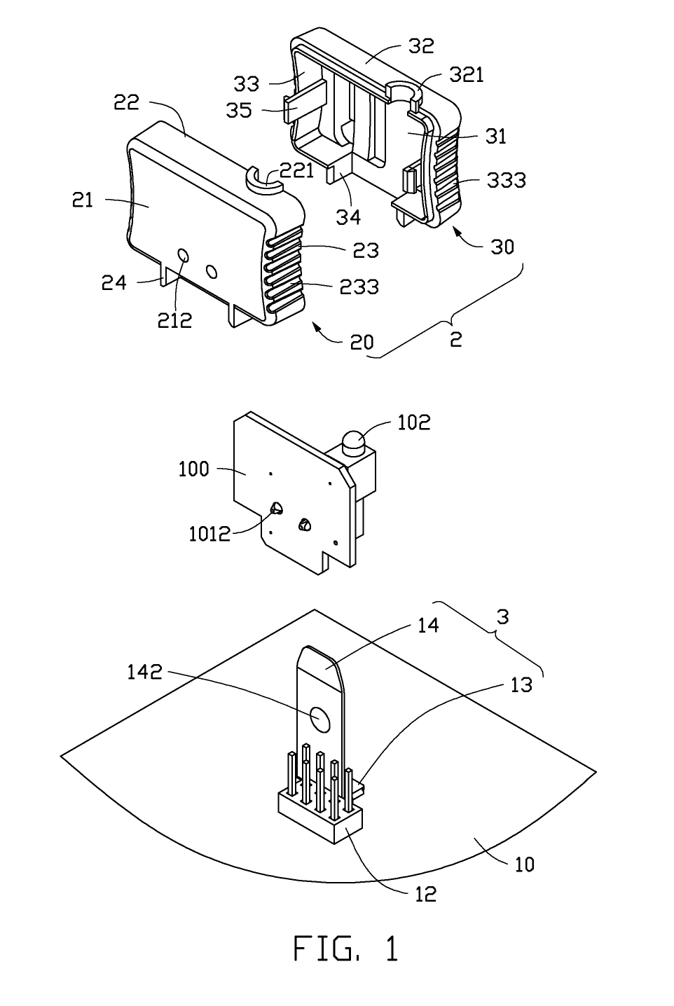

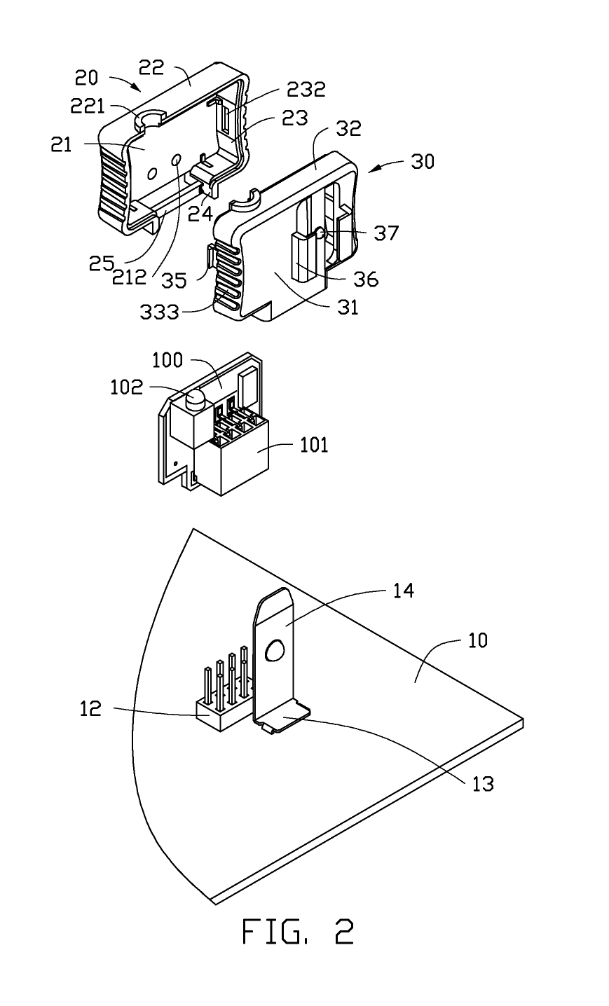

FIGS. 1 and 2 show an exemplary embodiment of an attachment mechanism for fastening an expansion card 100. The attachment mechanism includes a circuit board 10, a receiving member 2, and a positioning member 3. The receiving member 2 includes a first fastener 20 and a second fastener 30 opposite to the first fastener 20.

The circuit board 10 includes a first connector 12. The positioning member 3 is fastened to the circuit board 10 and is adjacent to the first connector 12. The positioning member 3 includes a fastening tab 13 fastened to the circuit board 10, and a mounting tab 14 extending substantially perpendicularly up from a side of the fastening tab 13. A mounting hole 142 is defined in the mounting tab 14.

The first fastener 20 includes a base plate 21, a top plate 22 extending substantially perpendicularly from a top side of the base plate 21, two side plates 23 extending from opposite ends of the base plate 21, respectively, two supporting feet 24 extending down from a bottom side of the base plate 21, and a connection pole 25 connected between the supporting feet 24. The base plate 21 defines two through holes 212. A semicircular receiving portion 221 is formed on a side of the top plate 22 opposite to the base plate 21. An engaging hole 232 is defined in an inner surface of each side plate 23. A plurality of skid-proof strips 233 is formed on an outer surface of each side plate 23.

The second fastener 30 includes a main body 31, a top plate 32 perpendicularly extending from a top side of the main body 31, two side plates 33 extending from opposite ends of the main body 31, and two supporting feet 34 extending down from a bottom side of the main body 31. Two hooks 35 extend from inner sides of opposite ends of the main body 31, respectively. Two substantially L-shaped clamping arms 36 extend from an outer side of the main body 31, opposite to each other. A protrusion 37 located between the clamping arms 36 extends from the outer side of the main body 31. A semicircular receiving portion 321 is formed on a side of the top plate 32 opposite to the main body 31. A plurality of skid-proof strips 333 is formed on an outer surface of each side plate 33.

A second connector 101 is mounted to a lower portion of a first side of the expansion card 100. An indication lamp 102 is mounted to an upper portion of the first side of the expansion card 100. Two pins 1012 extend from a second side of the expansion card 100 opposite to the first side.

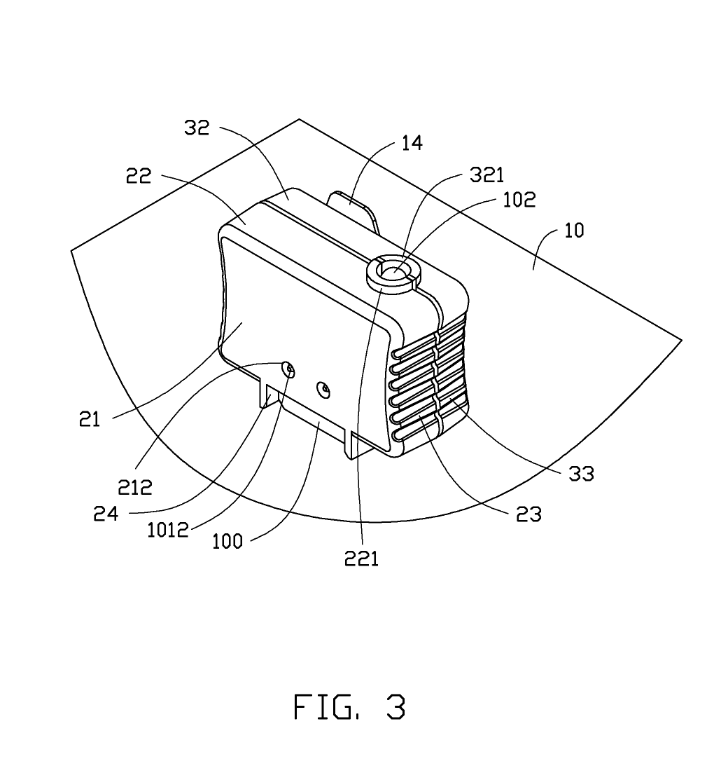

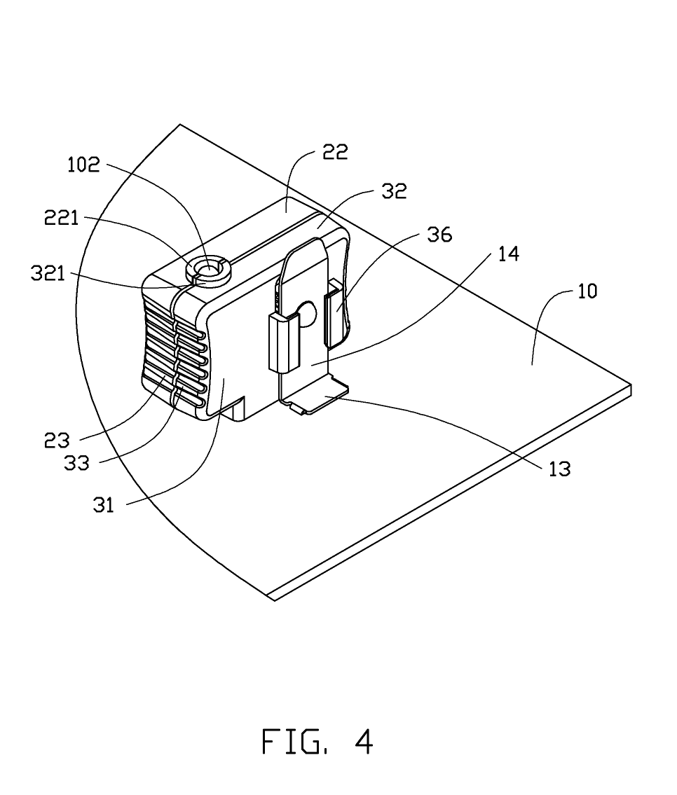

FIGS. 3 and 4 show that in assembly, the pins 1012 extend through the through holes 212 from an inner side of the first fastener 20. The expansion card 100 abuts against the base plate 21. A bottom of the second connector 101 abuts against the connection pole 25. The indication lamp 102 is partially received in the receiving portion 221. The hooks 35 engage in the engaging holes 232, so that the expansion card 100 is enclosed by the first fastener 20 and the second fastener 30. The base plate 21 is opposite to the main body 31. A side of the second connector 101 opposite to the expansion card 100 abuts against the main body 31. The receiving portions 221 and 321 receive the indication lamp 102, and the indication lamp 102 is exposed through the receiving portions 221 and 321. The second connector 101 is electrically connected to the first connector 12. The supporting feet 24 and 34 are supported on the circuit board 10. The clamping arms 36 embrace the mounting tab 14. The protrusion 37 engages in the mounting hole 142. Therefore, the expansion card 100 is fastened to the circuit board 10.

The expansion card 100 is received in the receiving member 2, and the second fastener 30 of the receiving member 2 engages with the positioning member 3 mounted to the circuit board 10. Therefore, the expansion card 100 is firmly fastened to the circuit board 10.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An attachment mechanism for fastening an expansion card, comprising:
a circuit board comprising a first connector to be electrically connected to a second connector of the expansion card;
a positioning member to be fastened to the circuit board; and
a receiving member for receiving the expansion card, the receiving member engaging with the positioning member.

2. The attachment mechanism of claim 1, wherein the receiving member comprises a first fastener, and a second fastener fastened to the first fastener, the expansion card is to be enclosed by the first fastener and the second fastener.

3. The attachment mechanism of claim 2, wherein the first fastener comprises a base plate for abutting against the expansion card, the base plate defines two through holes for two pins of the expansion card extending through.

4. The attachment mechanism of claim 3, wherein the second fastener comprises a main body opposite to the base plate, the main body abuts against the expansion card.

5. The attachment mechanism of claim 4, wherein the first fastener further comprises two side plates extending from opposite ends of the base plate, an inner surface of each side plate defines an engaging hole, two hooks extend from the main body and engage in the engaging holes of the corresponding side plates.

6. The attachment mechanism of claim 4, wherein the first fastener further comprises a first top plate extending from a top side of the base plate toward the main body, the second fastener further comprises a second top plate extending from a top side of the main body toward the base plate, each of the first top plate and the second top plate forms a receiving portion, the receiving portions of the first and second top plates are operable of receiving and exposing an indication lamp of the expansion card.

7. The attachment mechanism of claim 4, wherein the first fastener further comprises two first supporting feet extending down from the base plate and supported on the circuit board, the second fastener further comprises two second supporting feet extending down from the main body and supported on circuit board.

8. The attachment mechanism of claim 7, wherein the first fastener further comprises a connection pole connected between the first supporting feet of the first fastener, the connection pole abuts against the second connector of the expansion card.

9. The attachment mechanism of claim 1, wherein the positioning member comprises a mounting tab perpendicular to the circuit board, the mounting tab defines a mounting hole, the receiving member comprises a protrusion engaging in the mounting hole.

10. The attachment mechanism of claim 1, wherein the positioning member comprises a mounting tab perpendicular to the circuit board, the receiving member comprises two L-shaped clamping arms embracing the mounting tab.
